(19) United States
(12) Patent Application Publication
(10) Pub. No.: US 2010/0024497 A1
(43) Pub. Date: Feb. 4, 2010

(54) LOCK ASSEMBLY WITH PICKING RESISTANT SHIELD

(76) Inventor: Kun-Yu Wu, Sinjhuang City (TW)

Correspondence Address: PATENTTM.US, P. O. BOX 82788, PORTLAND, OR, 97282-0788, US

(21) Appl. No.: 12/185,669

(22) Filed: Aug. 4, 2008

(51) Int. Cl. E05B 17/00

(52) U.S. Cl. 70/419

(57) ABSTRACT

A lock assembly with a picking resistant shield has a main lock and a key. The main lock has a shield attached to a front end of the main lock. The shield has an inner recess and an outer recess smaller than the inner recess. The key has a neck corresponding to the outer recess of the shield and a driving tube corresponding to the inner recess of the shield and is selectively mounted into the shield to unlock the main lock. Thus, the shield prevents the main lock from being picked from the front end of the main lock by a picking tool. Personal goods or private matters being protected by the lock assembly with the picking resistant shield are safe.

### BACKGROUND OF THE INVENTION

1. Field of the Invention

The present invention relates to a lock assembly, especially to a lock assembly with a picking resistant shield that prevents the lock assembly from being picked.

2. Description of the Prior Arts

A lock assembly is commonly used to protect personal goods or private matters and has a main lock and a specific key. Only the key may unlock the main lock.

With reference to FIG. 5, a conventional lock assembly comprises a main lock (30) and a key (40).

The main lock (30) has a housing (31), a lock cylinder (32), a latch (33) and multiple pins (34).

The housing (31) is tubular and has a front end, a rear end, a keyhole (311) and an inner circular edge. The keyhole (311) is formed through the front end of the housing (31). The inner circular edge of the housing (31) is formed around the keyhole (311) of the housing (31).

The lock cylinder (32) is axially mounted in the housing (31) and has a front end, a rear end and a side surface. The rear end of the lock cylinder (32) protrudes out of the rear end of the housing (31). The side surface of the lock cylinder (32) is spaced at an interval with the inner circular edge of the housing (31) to form a gap between the side surface of the lock cylinder (32) and the inner circular edge of the housing (31).

The latch (33) is attached to the rear end of the lock cylinder (32) adjacent to the rear end of the housing (31).

The pins (34) are mounted in the housing (31), are arranged around the lock cylinder (32) and are visible through the gap between the side surface of the lock cylinder (32) and the inner circular edge of the housing (31).

The key (40) has front end and a driving tube (41). The driving tube (41) is formed on the front end of the key (40), is selectively inserted through the keyhole (311) of the housing (31) to push the pins (34), turn the lock cylinder (32) and the latch (33) and unlock the main lock (30).

However, since the pins (34) of the main lock (30) is exposed to the gap between the side surface of the lock cylinder (32) and the inner circular edge of the housing (31), anyone who want to illegally unlock the main lock (30) may push the pins (34) to specific positions from the front end of the housing (31) of the main lock (30) with a picking tool. Consequently, the personal goods or private matters being protected by the conventional lock assembly are still in danger of being stolen.

To overcome the shortcomings, the present invention provides a lock assembly with a picking resistant shield to mitigate or obviate the aforementioned problems.

### SUMMARY OF THE INVENTION

The main objective of the present invention is to provide a lock assembly with a picking resistant shield. The lock assembly has a main lock and a key. The main lock has a shield attached to a front end of the main lock. The shield has an inner recess and an outer recess smaller than the inner recess. The key has a neck corresponding to the outer recess of the shield and a driving tube corresponding to the inner recess of the shield and is selectively mounted into the shield to unlock the main lock.

The shield prevents the main lock from being picked from the front end of the main lock by a picking tool. Personal goods or private matters being protected by the lock assembly with the picking resistant shield are safe.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a lock assembly in accordance with the present invention;

FIG. 2 is an end view of a main lock of the lock assembly in FIG. 1, showing an inner recess in phantom line;

FIG. 3 is a side view in partial section of the lock assembly in FIG. 1, showing a key being mounted in the inner recess of the main lock;

FIG. 4 is an operational side view in partial section of the lock assembly in FIG. 1, showing the key being inserted into the main lock; and

FIG. 5 is an exploded perspective view of a conventional lock assembly in accordance with the prior art.

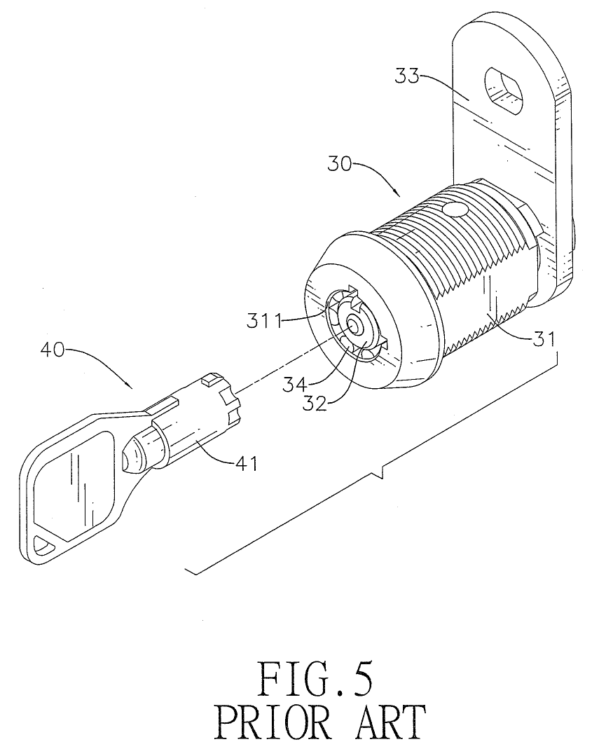

### DETAILED DESCRIPTION OF THE PREFERRED EMBODIMENTS

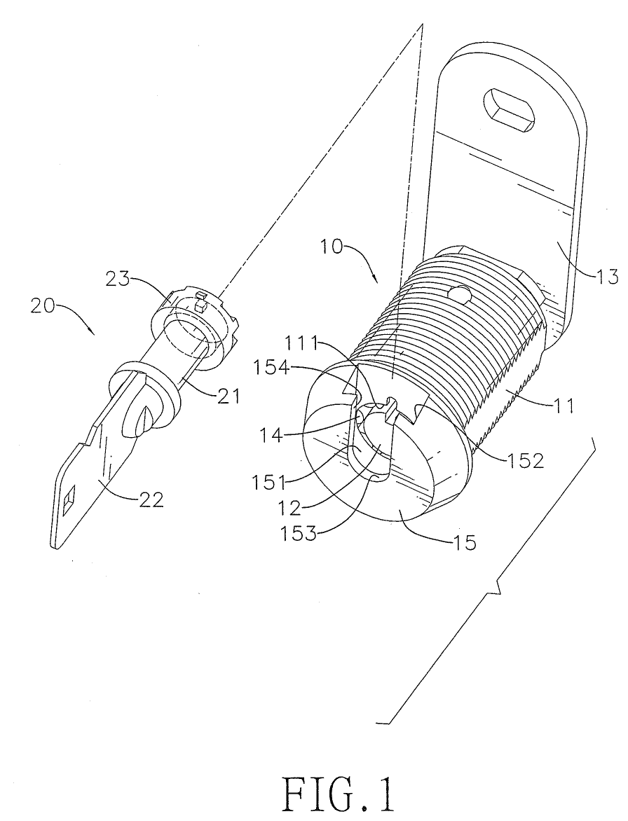

With reference to FIG. 1, a lock assembly with a picking resistant shield in accordance with the present invention comprises a main lock (10) and a key (20).

The main lock (10) has a housing (11), a lock cylinder (12), an optional latch (13), multiple optional pins (14) and a shield (15).

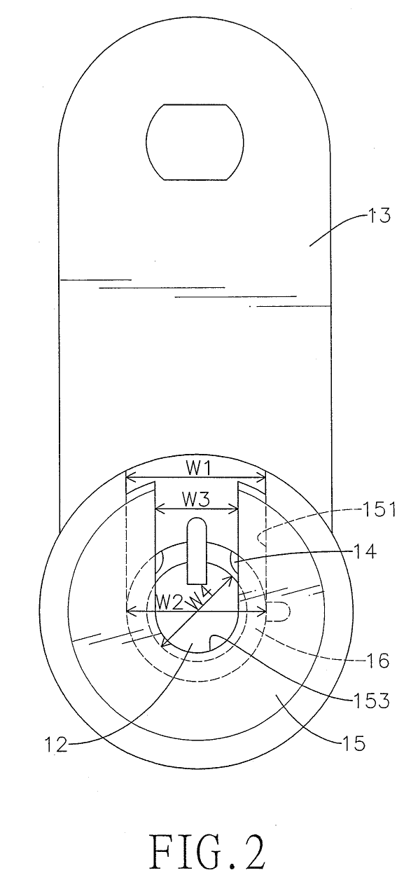

With further reference to FIG. 2, the housing (11) is tubular and has a front end, a rear end, a keyhole (111) and an inner circular edge. The keyhole (111) is formed through the front end of the housing (11) and has a diameter (W2). The inner circular edge of the housing (11) is formed around the keyhole (111) of the housing (11).

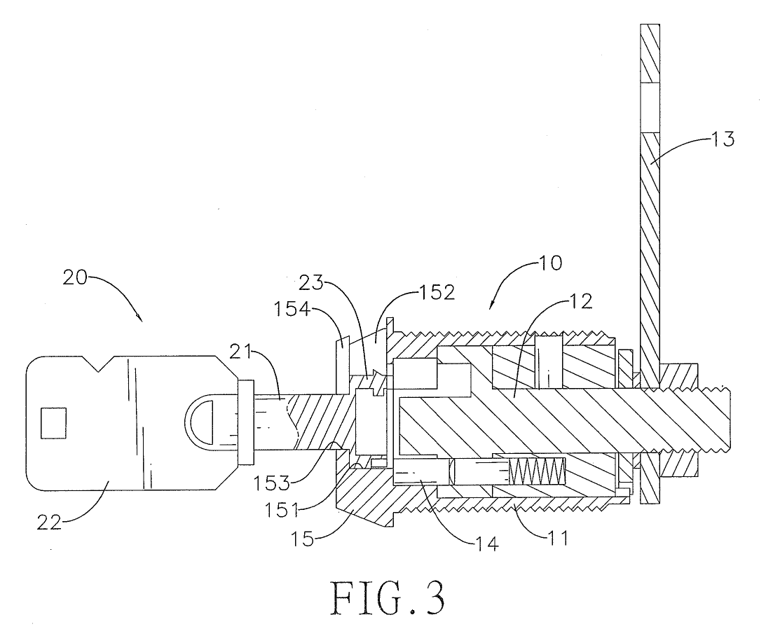

With further reference to FIG. 3, the lock cylinder (12) is axially mounted in the housing (11) and has a front end, a rear end, a side surface and a diameter (W4). The rear end of the lock cylinder (12) protrudes out of the rear end of the housing (11). The diameter (W4) of the lock cylinder (12) is shorter than the diameter (W2) of the keyhole (111) of the housing (11) to form a gap between the side surface of the lock cylinder (12) and the inner circular edge of the housing (11).

The latch (13) is attached securely to the rear end of the lock cylinder (12) adjacent to the rear end of the housing (11).

The pins (14) are mounted in the housing (11) and are arranged around the lock cylinder (12).

The shield (15) is attached securely to the front end of the housing (11) and has an inner end, an outer end, a side surface, an inner recess (151) and an outer recess (153). The inner end of the shield (15) corresponds to and is attached to the front end of the housing (11). The inner recess (151) is formed in the inner end of the shield (15), may be U-shaped in cross-section and has an opening (152) and a width (W1). The opening (152) of the inner recess (151) is formed in the side surface of the shield (15). The width (W1) of the inner recess (151) is equal to or larger than the diameter (W2) of the keyhole (111) of the housing (11). The outer recess (153) is formed in the outer end of the shield (15), communicates the inner recess (151) of the shield (15), may be U-shaped in cross-section and has an opening (154) and a width (W3). The opening (154) of the outer recess (153) is formed in the side surface of the shield (15) and communicates the opening (152) of the inner recess (151). The width (W3) of the outer recess (153) is shorter than the diameter (W4) of the lock cylinder (12).

Therefore, while looking from the front end of the housing (11), the gap between the side surface of the lock cylinder (12) and the inner circular edge of the housing (11) is mostly covered by the shield (15).

The key (20) has a neck (21), a handle (22) and a driving tube (23).

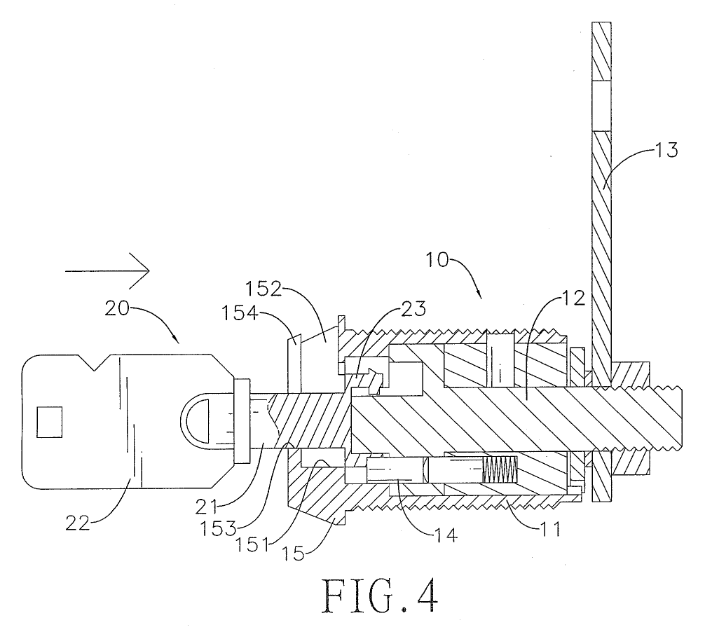

With further reference to FIG. 4, the neck (21) corresponds to and is selectively mounted into the outer recess (153) of the shield (15) from the opening (154) of the outer recess (153) of the shield (15) and has a holding end and an inserting end.

The handle (22) is formed on the holding end of the neck (21) to allow the key (20) to be held.

The driving tube (23) is formed on and protrudes from the inserting end of the neck (21), corresponds to the inner recess (151) of the shield (15) and the lock cylinder (12) of the main lock (10), is selectively mounted into the inner recess (151) of the shield (15) from the opening (152) of the inner recess (151) of the shield (15) and is selectively inserted into the housing (11) from the keyhole (111) of the housing (11) to unlock the main lock (10).

The lock assembly with the picking resistant shield as described has the following advantage. Since the gap between the side surface of the lock cylinder (12) and the inner circular edge of the housing (11) is mostly covered by the shield (15), the pins (14) of the main lock (10) are not picked from the front end of the housing (10). Therefore, personal goods or private matters being protected by the lock assembly with the picking resistant shield are safe.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A lock assembly comprising
a main lock having
a housing being tubular and having
a front end;
a rear end;
a keyhole being formed through the front end of the housing and having a diameter; and
an inner circular edge being formed around the keyhole of the housing;
a lock cylinder being axially mounted in the housing and having
a front end corresponding to the front end of the housing;
a rear end corresponding to the rear end of the housing;
a side surface; and
a diameter being shorter than the diameter of the keyhole of the housing; and
a shield being attached securely to the front end of the housing and having
an inner end corresponding to and being attached to the front end of the housing;
an outer end;
a side surface;
an inner recess being formed in the inner end of the shield and having
an opening being formed in the side surface of the shield; and
a width being equal to or larger than the diameter of the keyhole of the housing; and
an outer recess being formed in the outer end of the shield, communicating the inner recess of the shield and having
an opening being formed in the side surface of the shield and communicating the opening of the inner recess; and
a width being shorter than the diameter of the lock cylinder; and
a key having
a neck corresponding to and being selectively mounted into the outer recess of the shield from the opening of the outer recess of the shield and having
a holding end; and
an inserting end; and
a driving tube being formed on and protruding from the inserting end of the neck, corresponding to the inner recess of the shield and the lock cylinder of the main lock, being selectively mounted into the inner recess of the shield from the opening of the inner recess of the shield and being selectively inserted into the housing from the keyhole of the housing.

2. The lock assembly as claimed in claim 1, wherein the inner recess and the outer recess of the shield of the main lock are U-shaped in cross-section.

3. The lock assembly as claimed in claim 1, wherein the main lock further has multiple pins being mounted in the housing and being arranged around the lock cylinder.

4. The lock assembly as claimed in claim 2, wherein the main lock further has multiple pins being mounted in the housing and being arranged around the lock cylinder.

5. The lock assembly as claimed in claim 1, wherein
the rear end of the lock cylinder of the main lock protrudes out of the rear end of the housing; and
the main lock further has a latch being attached securely to the rear end of the lock cylinder adjacent to the rear end of the housing.

6. The lock assembly as claimed in claim 2, wherein
the rear end of the lock cylinder of the main lock protrudes out of the rear end of the housing; and
the main lock further has a latch being attached securely to the rear end of the lock cylinder adjacent to the rear end of the housing.

7. The lock assembly as claimed in claim 3, wherein
the rear end of the lock cylinder of the main lock protrudes out of the rear end of the housing; and
the main lock further has a latch being attached securely to the rear end of the lock cylinder adjacent to the rear end of the housing.

8. The lock assembly as claimed in claim 4, wherein
the rear end of the lock cylinder of the main lock protrudes out of the rear end of the housing; and
the main lock further has a latch being attached securely to the rear end of the lock cylinder adjacent to the rear end of the housing.

9. The lock assembly as claimed in claim 5, wherein the key further has a handle being formed on the holding end of the neck.

10. The lock assembly as claimed in claim 6, wherein the key further has a handle being formed on the holding end of the neck.

11. The lock assembly as claimed in claim 7, wherein the key further has a handle being formed on the holding end of the neck.

12. The lock assembly as claimed in claim 8, wherein the key further has a handle being formed on the holding end of the neck.
